(19) United States
(12) Patent Application Publication
(10) Pub. No.: US 2010/0292093 A1
(43) Pub. Date: Nov. 18, 2010

(54) BREAST CANCER PROFILES AND METHODS OF USE THEREOF

(76) Inventor: Wendy S. Rubinstein, Skokie, IL (US)

Correspondence Address: WILMERHALE/DC, 1875 PENNSYLVANIA AVE., NW, WASHINGTON, DC, 20006, US

(21) Appl. No.: 12/682,176

(22) PCT Filed: Oct. 17, 2008
(86) PCT No.: PCT/US08/80358

§ 371 Date: Aug. 2, 2010

Related U.S. Application Data
(60) Provisional application No. 60/960,892, filed on Oct. 18, 2007.

(51) Int. Cl. C40B 30/04

(52) U.S. Cl. 506/9

(57) ABSTRACT

This invention relates to the identification and use of gene expression profiles, patterns, suitable for the identification of breast cancer patient populations with an inherited predisposition to breast and ovarian cancer. The gene expression patterns may be embodied in nucleic acid expression, protein expression, or other expression formats and may be used in the study and/or determination of optimal treatment, cancer prevention, patient and family identification, and other uses. The invention also pertains to the identification of patients with sporadic breast cancer, where a similar biology to that of hereditary breast cancer is caused by alternative mechanisms such as epigenetic modification of BRCA1 or somatic mutation of other genes.

### GOVERNMENT LICENSE

The U.S. Government has a paid-up license in this invention and the right in limited circumstances to require the patent owner to license others on reasonable terms as provided for by the terms of National Institutes of Health (NIH) grant number P50 CA089018 awarded by the National Cancer Institute.

### FIELD OF THE INVENTION

This invention relates to the identification and use of gene expression profiles or patterns with clinical relevance to breast cancer.

### INTRODUCTION AND BACKGROUND OF THE INVENTION

### Breast Cancer and Genetic Risk

Approximately 212,920 new cases of invasive breast cancer, 61,980 in situ cases, and 40,970 deaths are expected to occur among US women in 2006 (Smigal C. et al. Trends in breast cancer by race and ethnicity: update 2006. CA: a Cancer Journal for Clinicians. 56(3):168-83, 2006.). Breast cancer is the leading cause of new cancers in women and comprises a third of all new cases. Breast cancer is the second leading cause of cancer mortality, accounting for 15% of the total deaths from cancer in women.

Breast cancer is a complex disease, resulting from an incompletely characterized interplay of genetic and environmental factors. About 5-10% of breast cancer is hereditary, i.e. due to the transmission of highly penetrant mutations in breast cancer predisposing genes. Within hereditary breast cancer families, mutation status is the overriding risk factor and genetic analysis can be used to clarify risk and guide medical management in a highly effective way. Genetic risk assessment consists of evaluating the pattern of cancers in the family, judging which of the known hereditary breast cancer syndromes fits the pattern, and pursuing genetic analysis.

A specific genetic syndrome can be elucidated in about half of hereditary breast cancer families. Additional genes remain to be described (de Jong M M, Nolte I M, to Meerman G J et al. Genes other than BRCA1 and BRCA2 involved in breast cancer susceptibility. J Med Genet 2002; 39(4):225-242). Risk-conferring alleles are conceptualized as high-penetrance genes with low prevalence [e.g. BRCA1 and BRCA2 [hereditary breast-ovarian cancer (HBOC) syndrome], TP53 (Li-Fraumeni syndrome), PTEN (Cowden syndrome), LKB1 (Peutz-Jeghers syndrome)] or low penetrance genes with high prevalence (possibly CHEK2 (Meijers-Heijboer H, van den O A, Klijn J et al. Low-penetrance susceptibility to breast cancer due to CHEK2(*)1100delC in noncarriers of BRCA1 or BRCA2 mutations. Nat Genet 2002; 31(1):55-59), ATM (Thorstenson Y R, Roxas A, Kroiss R et al. Contributions of ATM mutations to familial breast and ovarian cancer. Cancer Res 2003; 63(12):3325-3333) and the TGFBR1*6A allele (Kaklamani V G, Hou N, Bian Y et al. TGFBR1*6A and cancer risk: a meta-analysis of seven case-control studies. J Clin Oncol 2003; 21(17):3236-3243)

### BRCA1 and BRCA2 Gene Function

BRCA1 and BRCA2 encode very large proteins with 1,863 and 3,418 amino acids, respectively; each bears little homology to other known proteins or to each other. BRCA1 appears to play a role in numerous cellular functions including transcriptional regulation and influence of estrogen receptor activity, chromatin remodeling, DNA damage repair (homologous recombination and repair of transcription-coupled oxidation-induced DNA damage), centrosome duplication, cell growth, apoptosis, and cell cycle checkpoint control (Deng C X, Brodie S G. Roles of BRCA1 and its interacting proteins. Bioessays 2000; 22(8):728-737). BRCA1 contains an N-terminal RING domain that interacts with BARD1. Two BRCA1 C-terminal (BRCT) domains are present, which are found in proteins involved in DNA repair and control of the cell cycle. BRCA2 contains eight highly conserved BRC repeats of 30 to 40 residues in exon 11 which bind to RAD51, a key recombinational repair protein. After exposure of cells to DNA damage, BRCA1 relocalizes from nuclear foci to sites of DNA synthesis and becomes hyperphosphorylated. BARD1, BRCA2, and RAD51 all relocalize with BRCA1 (Scully R, Livingston D M. In search of the tumour-suppressor functions of BRCA1 and BRCA2. Nature 2000; 408(6811):429-432). Germline mutations in BRCA1 are widely distributed throughout the gene (FIG. 1).

### Clinical Significance of BRCA1 and BRCA2 Mutations

BRCA1 and BRCA2 mutations predispose female carriers to a high lifetime risk of breast cancer (>80%) and ovarian cancer (40-65% for BRCA1 carriers and 20% for BRCA2 carriers). The clinical features and management of HBOC syndrome have been reviewed (Lynch H T, Snyder C L, Lynch J F, Riley B D, Rubinstein W S. Hereditary breast-ovarian cancer at the bedside: role of the medical oncologist. J Clin Oncol 2003; 21(4):740-753). Average ages of breast and ovarian cancer onset are generally younger for BRCA1 carriers than BRCA2 carriers, but each can manifest as breast cancer in the twenties.

Male breast cancer is seen in excess in BRCA1 and BRCA2 families, with about two thirds of positive cases involving BRCA2 and one third involving BRCA1 (Frank T S, Deffenbaugh A M, Reid J E, Hulick M, Ward B E, Lingenfelter B et al. Clinical characteristics of individuals with germline mutations in BRCA1 and BRCA2: analysis of 10,000 individuals. J Clin Oncol 2002; 20(6):1480-1490). Lifetime risk of breast cancer is about 5-6% for male BRCA1 and BRCA2 carriers.

Many effective cancer risk management strategies are available for BRCA1 and BRCA2 carriers, as well as for families with a high clinical suspicion of genetic predisposition (Scheuer L, Kauff N, Robson M et al. Outcome of preventive surgery and screening for breast and ovarian cancer in BRCA mutation carriers. J Clin Oncol 2002; 20(5):1260-1268). The chief value of genetic testing is to confirm the need for medical interventions, particularly those that are irreversible such as prophylactic mastectomy and prophylactic oophorectomy. As well, a true negative result (i.e. in the setting of a known familial mutation) obviates the need for aggressive surveillance and prevention measures, and provides reassurance to the person tested as well as to their offspring. Surveillance and management for HBOC syndrome includes consideration of chemoprevention of breast (e.g. tamoxifen) and ovarian (e.g. oral contraceptives) cancers, MRI surveillance for breast cancer, and early breast cancer surveillance (age 25 years) in at-risk female relatives(Scheuer L, Kauff N, Robson M, Kelly B, Barakat R, Satagopan J et al. Outcome of preventive surgery and screening for breast and ovarian cancer in BRCA mutation carriers. J Clin Oncol 2002; 20(5):1260-1268).

### Distinctive Pathobiological Features

BRCA1 and BRCA2 breast cancers have distinct biological features which differentiate them from sporadic or familial (non-BRCA1/2) breast cancers. At present, these distinguishing features are better recognized for BRCA1 than BRCA2 tumors.

A series of histopathologic and immunohistochemical (IHC) studies conducted by the Breast Cancer Linkage Consortium (BCLC) and other groups have revealed that BRCA1 breast tumors, as compared with vs. age-matched sporadic breast cancers unselected for family history, are characterized by higher grade, higher mitotic counts, a greater degree of nuclear pleomorphism, less tubule formation, steroid receptor (ER/PR) negativity, HER-2 receptor negativity, lower p27(Kip1) protein levels, and cyclin E expression (Pathology of familial breast cancer: differences between breast cancers in carriers of BRCA1 or BRCA2 mutations and sporadic cases. Breast Cancer Linkage Consortium. Lancet 1997; 349(9064):1505-1510; Lakhani S R, Jacquemier J, Sloane J P et al. Multifactorial analysis of differences between sporadic breast cancers and cancers involving BRCA1 and BRCA2 mutations. J Natl Cancer Inst 1998; 90(15):1138-1145; Chappuis P O, Kapusta L, Begin L R et al. Germline BRCA1/2 mutations and p27(Kip1) protein levels independently predict outcome after breast cancer. J Clin Oncol 2000; 18(24):4045-52; Lakhani S R, Van D, V, Jacquemier J et al. The pathology of familial breast cancer: predictive value of immunohistochemical markers estrogen receptor, progesterone receptor, HER-2, and p53 in patients with mutations in BRCA1 and BRCA2. J Clin Oncol 2002; 20(9):2310-2318).

BRCA1 tumors share features of basal epithelial breast tumors such as cytokeratin (CK)5/6 expression and may largely overlap with this tumor subclass, based on IHC and gene expression profiling data. The basal/myoepithelial phenotype is seen in 2-18% of breast tumors, which are notable for IHC positivity for intermediate filaments e.g. CK5, CK14, usually high grade, with large central acellular zones comprising necrosis, tissue infarction, collagen, and hyaline material, and ER, PR, HER-2 negative receptor status (Lakhani S R, Reis-Filho J S, Fulford L et al. Prediction of BRCA1 status in patients with breast cancer using estrogen receptor and basal phenotype. Clin Cancer Res 2005; 11(14):5175-5180). A model was developed for incorporating ER, CK14 and CK5/6 markers to select cases for BRCA1 genetic testing. Marker status of ER negative and CK5/6 positive resulted in sensitivity=56%, specificity =97%, positive predictive value=28% and negative predictive value=99% with an area under the ROC curve=0.77. The use of ER negative, CK14 and CK5/6 positive markers resulted in an area under the ROC curve=0.87.

BRCA2 tumors are less distinctive, showing a higher overall grade as a result of exhibiting less tubule formation, and a higher proportion of continuous pushing margins, but are not significantly different with respect to mitoses, pleomorphism, and steroid receptor expression (Lakhani S R, Jacquemier J, Sloane J P et al. Multifactorial analysis of differences between sporadic breast cancers and cancers involving BRCA1 and BRCA2 mutations. J Natl Cancer Inst 1998; 90(15):1138-1145; Lakhani S R, Van D, V, Jacquemier J et al. The pathology of familial breast cancer: predictive value of immunohistochemical markers estrogen receptor, progesterone receptor, HER-2, and p53 in patients with mutations in BRCA1 and BRCA2. J Clin Oncol 2002; 20(9):2310-2318; Pathology of familial breast cancer: differences between breast cancers in carriers of BRCA1 or BRCA2 mutations and sporadic cases. Breast Cancer Linkage Consortium. Lancet 1997; 349(9064):1505-1510). A comparison of BRCA2 germline-mutated breast cancer vs. familial breast cancer using IHC of DNA repair proteins RAD51, RAD50, XRCC3, ATM, PCNA and CHEK2 showed that these tumors could be differentiated (Honrado E, Osorio A, Palacios J et al. Immunohistochemical expression of DNA repair proteins in familial breast cancer differentiate BRCA2-associated tumors. J Clin Oncol 2005; 23(30):7503-7511). CHEK2 expression was increased in BRCA1 and BRCA2 tumors vs. non-BRCA1/2 and sporadic tumors. BRCA2 breast tumors showed absent RAD51 nuclear expression and had cytoplasmic RAD51 expression. The results were validated with a new series of patient cases and a multivariate model was developed with RAD51 and CHEK2 that distinguishes BRCA2 from non-BRCA1/2 tumors with an estimated probability of ≧76%.

BRCA1 and BRCA2 breast tumors are more likely to overexpress p53 and more commonly harbor somatic mutations in the TP53 gene with an altered mutational spectrum, suggesting that that impaired DNA repair function may play a central role in molecular pathogenesis (Greenblatt M S, Chappuis P O, Bond J P, Hamel N, Foulkes W D. TP53 mutations in breast cancer associated with BRCA1 or BRCA2 germ-line mutations: distinctive spectrum and structural distribution. Cancer Res 2001; 61(10):4092-4097).

### Gene Expression Profiling of BRCA Breast Tumors

Gene expression profiling (GEP) has become an important tool for the comprehensive analysis of gene expression in diverse biological samples and has emerged as a means for refining the taxonomy of cancers. This method may help to clarify prognosis, optimize treatment, elucidate molecular progression pathways, and lead to the development of new cancer therapeutics tailored to the underlying etiology. The independent prognostic value of gene expression signatures in early stage breast cancer has already led to the development of clinical tests and engendered clinical trials ('t Veer L J, Dai H, van de Vijver M J et al. Gene expression profiling predicts clinical outcome of breast cancer. Nature 2002; 415(6871):530-536; Paik S, Shak S, Tang G et al. A multigene assay to predict recurrence of tamoxifen-treated, node-negative breast cancer. N Engl J Med 2004; 351(27):2817-2826: Esteva F J, Sahin A A, Cristofanilli M et al. Prognostic role of a multigene reverse transcriptase-PCR assay in patients with node-negative breast cancer not receiving adjuvant systemic therapy. Clin Cancer Res 2005; 11(9):3315-3319; Tuma R S. A big trial for a new technology: TransBIG Project takes microarrays into clinical trials. J Natl Cancer Inst 2004; 96(9):648-649).

Gene expression patterns have been used to discern “molecular portraits” of breast tumors (Perou C M, Sorlie T, Eisen M B et al. Molecular portraits of human breast tumours. Nature 2000; 406(6797):747-752). Breast tumor subtypes distinguished by DNA microarrays appear to represent distinct biological entities: luminal subtypes A and B, ERBB2+ subtype, basal subtype, and normal breast-like subtype (Perou C M, Sorlie T, Eisen M B et al. Molecular portraits of human breast tumours. Nature 2000; 406(6797):747-752).

Genomic methods have been employed to “bin” hereditary tumors. For example, comparative genomic hybridization of non-BRCA1/2 hereditary breast tumors was used to guide the mapping of additional susceptibility genes (Kainu T, Juo S H, Desper R et al. Somatic deletions in hereditary breast cancers implicate 13q21 as a putative novel breast cancer susceptibility locus. Proc Natl Acad Sci U S A 2000; 97(17):9603-9608), and distinguished BRCA1-mutated from sporadic breast tumors with an accuracy of 84% (Wessels L F, van Welsem T, Hart A A, van't Veer L J, Reinders M J, Nederlof P M. Molecular classification of breast carcinomas by comparative genomic hybridization: a specific somatic genetic profile for BRCA1 tumors. Cancer Res 2002; 62(23):7110-7117).

Notably, GEP can accurately distinguish BRCA1, BRCA2, and sporadic breast tumors (Hedenfalk I, Duggan D, Chen Y et al. Gene-expression profiles in hereditary breast cancer. N Engl J Med 2001; 344(8):539-548; 't Veer L J, Dai H, van de Vijver M J et al. Gene expression profiling predicts clinical outcome of breast cancer. Nature 2002; 415(6871):530-536). Review of 176 differentially expressed genes revealed a common theme in BRCA1 mutated samples, involving the coordinated transcriptional activation of two major cellular processes, DNA repair and apoptosis (Hedenfalk I, Duggan D, Chen Y et al. Gene-expression profiles in hereditary breast cancer. N Engl J Med 2001; 344(8):539-548). A BRCA1 signature was also discerned in a study which used GEP to identify “poor prognosis” signatures in breast tumors from young women with node-negative disease ('t Veer L J, Dai H, van de Vijver M J et al. Gene expression profiling predicts clinical outcome of breast cancer. Nature 2002; 415(6871):530-536). Using an optimal set of 100 BRCA1 reporter genes, the investigators were able to distinguish BRCA1 from sporadic ER negative breast cancers with an accuracy of 95%. “Misclassified” sporadic tumors had decreased BRCA1 expression and promoter hypermethylation, reflecting a common biology between germline- and somatically inactivated tumors and showing the centrality of BRCA1 in determining the molecular phenotype (Hedenfalk I, Duggan D, Chen Y et al. Gene-expression profiles in hereditary breast cancer. N Engl J Med 2001; 344(8):539-548; 't Veer L J, Dai H, van de Vijver M J et al. Gene expression profiling predicts clinical outcome of breast cancer. Nature 2002; 415(6871):530-536). All of the BRCA1 tumors fell within the basal subgroup, indicative of a distinctive biology associated with a poor prognosis (Sorlie T, Tibshirani R, Parker J et al. Repeated observation of breast tumor subtypes in independent gene expression data sets. Proc Natl Acad Sci U S A 2003; 100(14):8418-8423). BRCA2 tumors fell within the luminal A subtype.

Gene expression profiling studies demonstrate that a highly penetrant susceptibility gene can markedly influence the molecular phenotype, histology, and prognosis of the resulting breast tumor. Moreover, the molecular phenotype can be examined to gain insight into the specific cellular pathways that have been disrupted (Hedenfalk I, Duggan D, Chen Y et al. Gene-expression profiles in hereditary breast cancer. N Engl J Med 2001; 344(8):539-548).

### Prognosis

BRCA1 breast tumors show a poorer survival rate as compared with matched sporadic and BRCA2 controls in some, but not all studies(Robson M E, Boyd J, Borgen P I, Cody H S 3. Hereditary breast cancer. Curr Probl Surg 2001; 38(6):387-480; Robson M E, Chappuis P O, Satagopan J et al. A combined analysis of outcome following breast cancer: differences in survival based on BRCA1/BRCA2 mutation status and administration of adjuvant treatment. Breast Cancer Res 2004; 6(1):R8-R17). The survival disadvantage in BRCA1 carriers may disappear if patients with small, node-negative grade 3 tumors are treated with chemotherapy (Robson M E, Boyd J, Borgen P I, Cody H S 3. Hereditary breast cancer. Curr Probl Surg 2001; 38(6):387-480; Robson M E, Chappuis P O, Satagopan J et al. A combined analysis of outcome following breast cancer: differences in survival based on BRCA1/BRCA2 mutation status and administration of adjuvant treatment. Breast Cancer Res 2004; 6(1):R8-R17; Evans D G, Howell A. Are B. Breast Cancer Res 2004; 6(1):E7).

Interestingly, the possibility of worse prognosis with node-negative tumors is paralleled by a large study showing disruption of the expected positive correlation between breast tumor size and lymph node status in BRCA1 breast cancers (Foulkes W D, Metcalfe K, Hanna W et al. Disruption of the expected positive correlation between breast tumor size and lymph node status in BRCA1-related breast carcinoma. Cancer 2003; 98(8):1569-1577). Among 1555 women with invasive breast cancers diagnosed between 1975-1997 comprised of 276 BRCA1 mutation carriers, 136 BRCA2 carriers, and 1143 women without a known mutation (208 BRCA1/BRCA2 noncarriers and 935 untested women), a highly significant positive correlation was found, as expected, between tumor size and the frequency of positive axillary lymph nodes among BRCA1/BRCA2 noncarriers, BRCA2 carriers, untested women (overall P<0.0001 for each). Notably however, no clear correlation was found between tumor size and positive lymph node status in BRCA1 carriers (overall P=0.20). If this relationship seen in most tumors is lost, then it stands to reason that small, lymph-node negative BRCA1 tumors may nonetheless carry an adverse prognosis. If such tumors are amenable to treatment, then a more aggressive approach (i.e. chemotherapy for small, node-negative tumors) might be warranted.

Clinical survival studies are intriguing, particularly when placed into context with characteristics of basal tumors. Basal tumors are characteristically large and express low levels of ER, HER2, and p27Kip1, high levels of cyclin E, with nuclear p53 and intratumoral vascular nests (also referred to as glomeruloid-microvascular-proliferation or GMP) [Foulkes W D, Brunet J S, Stefansson I M et al. The prognostic implication of the basal-like (cyclin E high/p27 low/p53+/glomeruloid-microvascular-proliferation+) phenotype of BRCA1-related breast cancer. Cancer Res 2004; 64(3):830-835]. All of these factors are associated with a poor outcome in univariate analyses, and tumor markers most closely linked to the basal phenotype (p53, p27Kip1, cyclin E, and GMP) are independent predictors of poor outcome. Taken together, these data suggest that much of the inferior survival experienced by BRCA1 carriers with breast cancer—particularly those with lymph node-negative disease—may be attributable to the basal epithelial phenotype of these cancers (Foulkes W D, Brunet J S, Stefansson I M et al. The prognostic implication of the basal-like (cyclin E high/p27 low/p53+/glomeruloid-microvascular-proliferation+) phenotype of BRCA1-related breast cancer. Cancer Res 2004; 64(3):830-835).

A study examining the efficacy of neo-adjuvant chemotherapy found a better clinical response rate in BRCA1/2 carriers than in non-carriers. The probability of achieving a complete response in BRCA1/2 carriers seems to be independent of stage, suggesting that if inferior survival is a characteristic of BRCA tumors, it may be amenable to treatment using chemotherapy (Chappuis P O et al. A significant response to neoadjuvant chemotherapy in BRCA1/2 related breast cancer. J Med Genet 2002; 39(8):608-610).

### Treatment Tailored to Genotype-Chemotherapy

Foulkes has recently reviewed the in vitro and in vivo data on chemosensitivity of BRCA1/2 breast tumors (Foulkes WD. BRCA1 and BRCA2: chemosensitivity, treatment outcomes and prognosis. Fam Cancer 2006; 5(2):135-142). Questions that are ripe for inquiry include whether platinum-based therapies are more effective than taxanes for BRCA1/2 carriers. While anthracycline treatment has shown good results in the clinical setting, the data are not definitive and the in vitro data are less encouraging. Randomized, controlled clinical trials will be required to answer these questions. This raises the logistical issues involved in elucidating the mutation status of BRCA1/2 carriers at the time of breast cancer diagnosis, so as to enable treatment studies.

### Targeting of Therapy to Underlying Biology

BRCA1 and BRCA2 are important for DNA double strand (DS) break repair by homologous recombination. Poly(ADP-ribose) polymerase (PARP) is an enzyme involved in base excision repair, a key pathway in the repair of DNA single strand (SS) breaks. BRCA1 or BRCA2 dysfunction profoundly sensitizes cells to the inhibition of PARP enzymatic activity, resulting in chromosomal instability, cell cycle arrest and subsequent apoptosis. This seems to be because the inhibition of PARP leads to the persistence of DNA lesions normally repaired by homologous recombination. These results illustrate how different pathways cooperate to repair damage, and suggest that the targeted inhibition of particular DNA repair pathways may allow the design of specific and less toxic therapies for cancer (Farmer H, McCabe N, Lord C J et al. Targeting the DNA repair defect in BRCA mutant cells as a therapeutic strategy. Nature 2005; 434(7035):917-921).

PARP1 facilitates DNA repair by binding to DNA breaks and attracting DNA repair proteins to the site of damage. Nevertheless, PARP−/− mice are viable, fertile and do not develop early onset tumours. PARP inhibitors trigger g-H2AX and RAD51 foci formation. Bryant et al. (Bryant H E, Schultz N, Thomas H D et al. Specific killing of BRCA2-deficient tumours with inhibitors of poly(ADP-ribose) polymerase. Nature 2005; 434(7035):913-917) propose that, in the absence of PARP1, spontaneous SS breaks collapse replication forks and trigger homologous recombination for repair. Furthermore, they show that BRCA2-deficient cells, as a result of their deficiency in homologous recombination, are acutely sensitive to PARP inhibitors, presumably because resultant collapsed replication forks are no longer repaired. Thus, PARP1 activity is essential in homologous recombination-deficient BRCA2 mutant cells. They exploit this requirement in order to kill BRCA2-deficient tumours by PARP inhibition alone. Treatment with PARP inhibitors is likely to be highly tumour specific, because only the tumours (which are BRCA2−/−) in BRCA2+/− patients are defective in homologous recombination. The use of an inhibitor of a DNA repair enzyme alone to selectively kill a tumour, in the absence of an exogenous DNA-damaging agent, represents a new concept in cancer treatment.

### SUMMARY OF THE INVENTION

The method described herein relates to the identification of gene expression profiles or patterns of certain genes linked to the function of a gene known as BRCA1 in breast or ovarian cancer. The method is useful for the identification of individuals with hereditary predisposition to breast and ovarian cancer, such that appropriate cancer prevention or treatment options may be implemented.

In particular, the method described here relates to detecting the presence of hereditary mutations in BRCA1 or the BRCA1 pathway which disrupt downstream gene expression. Preferably, the method is applied to archival breast or ovarian tissue samples which have been formalin-fixed and embedded in paraffin (FFPE). The mRNA samples in such FFPE tissues are degraded and may not be useful for conventional DNA arrays. Thus, in one embodiment of the method described here, the gene profiles are established using a DNA array designed to amplify mRNA signal from degraded samples embedded in paraffin following formalin fixation. Most preferably, the DNA array is an Illumina DASL array (a cDNA-mediated annealing, selection, extension, and ligation assay) or other array specifically designed for degraded mRNA samples.

The method of using gene expression profiling to detect the presence of functional BRCA1 mutations is independent of the estrogen-receptor (ER) status of the tissue sample being analyzed. Thus, ER-positive tissue samples from breast tissue specimens will generate data that are similar to ER-negative samples for purposes of BRCA1 analysis using the method described herein.

In one embodiment of the method described here, the gene expression profile is established by selecting at least 10 genes from a group of 128 candidates and analyzing the mRNA expression using a DNA array. In one especially preferred embodiment, 13 genes from the larger group of 128 genes are profiled to distinguish sporadic BRCA1 mutations from hereditary mutations. In another embodiment of this method, at least 2 genes from the subset of 13 genes are selected for analysis of mRNA expression in FFPE breast or ovarian tissue.

In a further embodiment of this method, the sensitivity of the method in detecting hereditary BRCA1 mutations in FFPE tissues is greater than or equal to 70%. In a still further embodiment of this method, the sensitivity of this method in detecting hereditary BRCA1 mutations in FFPE tissue is greater than or equal to 80%.

In another aspect of the described method, the specificity of the method in distinguishing between sporadic and hereditary BRCA1 mutations is greater than or equal to 70%. A still further aspect of this method provides for distinguishing between sporadic and hereditary BRCA1 mutations with a specificity greater than or equal to 80%.

In an alternative embodiment, the method can be used to detect loss of BRCA1 function in cancers that are the result of somatic pathways including genes that are upstream or downstream of BRCA1 in a biological pathway. These upstream or downstream genes regulate BRCA1 function and may decrease the activity of BRCA1, resulting in a gene profile or pattern that is similar to when the mutations occur in BRCA1 itself.

### BRIEF DESCRIPTION OF THE FIGURES

FIG. 1 is a graph indicating that germline BRCA1 mutations in breast cancer specimens that this invention is capable of identifying are widely distributed across the BRCA1 gene.

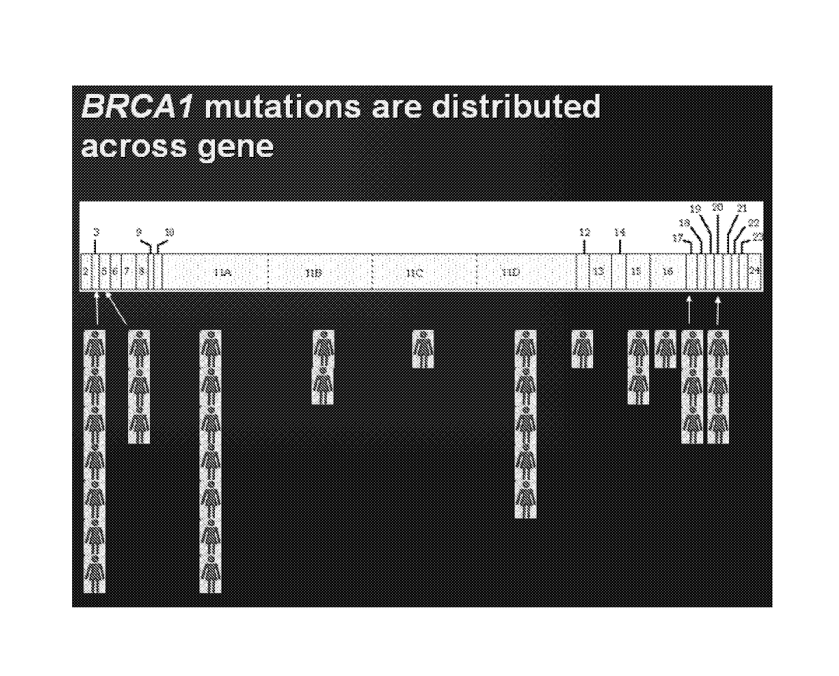

FIG. 2 illustrates gene expression profiles of 14 probes (for 13 genes) that are differentially expressed in BRCA1-mutated breast tumors in comparison with sporadic breast tumors.

FIG. 3 Plot of BRCA1 expression levels vs. methylation status of BRCA1 promoter. Among sporadic breast cancers, BRCA1 expression levels were inversely correlated with methylation of the BRCA1 promoter (P<0.01).

FIG. 4 is a graph showing the relationship of RNA quality vs. age of archival sample. High Ct value reflects poorer RNA quality. Age of archival material is not predictive of sample quality. The oldest sample (39 years) demonstrates one of the highest quality RNAs.

FIG. 5 is a chart showing the distribution of genes selected for the custom array into several functional categories, with particular weighting towards transcriptional regulation, cell cycle control, and DNA repair.

FIG. 6 is a graph showing qPCR data for MAGEA4 mRNA expression comparing BRCA1 mutated samples (ER positive and ER negative) versus sporadic (ER positive and ER negative) samples.

FIG. 7 is a graph showing qPCR data for SPIB mRNA expression comparing BRCA1 mutated samples (ER positive and ER negative) versus sporadic (ER positive and ER negative) samples.

FIG. 8 is a graph showing qPCR data for BRCA2 mRNA expression comparing BRCA1 mutated samples (ER positive and ER negative) versus sporadic (ER positive and ER negative) samples.

FIG. 9 is a side-by-side comparison of graphs generated using the MAGE A4 qPCR data in FIG. 6 compared to data generated using a DASL array.

FIG. 10 is a side-by-side comparison of graphs generated using the SPIB qPCR data in FIG. 7 compared to data generated using a DASL array.

FIG. 11 is a side-by-side comparison of graphs generated using the BRCA2 qPCR data in FIG. 8 compared to data generated using a DASL array.

TABLE 1 is a chart depicting the gene ontology classification of 120 non-control genes selected for the custom array.

TABLE 2 is a chart depicting genes in the BRCA1 classifier which are implicated in stem cell biology.

TABLE 3 is a chart listing the gene symbols and descriptions of the genes in the 128-gene array.

TABLE 4 is a chart listing the various database identifiers for the genes in the 128-gene array.

TABLE 5 is a chart listing the 13-gene BRCA1 classifier selected from the broader 128-gene array.

### DETAILED DESCRIPTION OF VARIOUS EMBODIMENTS

The present invention relates to the use of gene expression profiles (alternatively described as “profiles” or “signatures”) which are clinically relevant to breast cancer (for background purposes, please see Erlander et al., U.S. Patent Application Publication US 2005/0095607, hereby incorporated by reference in its entirety). In particular, the identities of genes which are correlated with hereditary breast cancer due to inherited mutations in the BRCA1 gene are provided. The gene expression profiles, whether embodied in nucleic acid expression, protein expression, or other expression formats, may be used to identify breast tumors with non-functional BRCA1 genes. Non-functioning of the BRCA1 gene may be due to germline mutations in the BRCA1 gene and/or acquired loss of function in the BRCA1 gene. Identification of breast tumors with BRCA1 loss of function is not solely dependent on analysis of the BRCA1 gene, but relies on analysis of additional genes and their pattern of expression. The methods described herein may be used to define the functional and clinical significance of variants in the BRCA1 gene, including missense mutations, thereby categorizing variants as disease-causing or clinically benign. The methods relate to the analysis of breast tumors including but not limited to archival tumor materials that are formalin-fixed and paraffin-embedded.

The identification of BRCA1 and BRCA2 germline mutation carriers is done primarily for the purpose of cancer risk management. A wide variety of clinically effective early detection and prevention strategies are available to female carriers. In order to take full advantage of these clinical treatments, the mutation status must be identified. This is currently done using direct analysis of the BRCA1 and BRCA2 genes mainly through DNA sequencing. DNA expression analysis may also be conducted in conjunction with protein expression analysis by various methods. For example, mRNA levels for genes relating to BRCA1 may be co-analyzed with protein expression levels by employing such methods as immunohistochemistry (IHC).

While one gene may be accurate to discriminate BRCA1 loss of function, more genes will tend to provide more accuracy. It is contemplated that the method disclosed herein use multiple genes disclosed in TABLE 3.

As used herein, these terms shall be defined as follows:

“Gene expression profile or pattern” shall refer to the mRNA expression of certain genes that are either over-expressed or under-expressed when BRCA1 is mutated in comparison to a normal or functional BRCA1 gene. Combining the data of at least 2 individual genes constitutes a profile or pattern which can be used to assess the functional status of the BRCA1 gene.

“Array” or “microarray” refers to a substantially 2-dimensional arrangement of polynucleotides specifically placed on a solid support such as glass, plastic, beads, or other synthetic material in such a way that the location of the polynucleotide on the array is fixed in relation to other polynucleotides on the same array, thus allowing for the user to correlate data from an assay using the array with specific polynucleotides of known locations on the array. An array may allow for enzymatic reactions on the surface of the support such as annealing of primers or other exogenous polynucleotides, extension of said polynucleotides, or ligating of added nucleotides or polynucleotides.

“Mutation” refers to a substitution, deletion, or addition of a nucleotide or nucleotides to the wildtype sequence of a gene as identified herein. Mutations may be both “functional” or “non-functional”, i.e. a “silent” mutation may occur where a substitution mutation results in the same amino acid sequence for the translated gene product, or a mutation may result in an amino acid sequence change which renders the translated protein non-functional. A mutation in a gene of interest may result in genes further downstream in a biological cascade to change mRNA expression either positively or negatively.

“Specificity” of the method described herein refers to the percent accuracy with which the method distinguishes gene profiles of sporadic tumors versus tumors arising from hereditary mutations.

“Sensitivity” of the method described herein refers to the percent accuracy with which the method detects hereditary BRCA1 mutations in tissue samples containing functional mutations.

“Distinguishes” as used herein denotes the usefulness of an assay in categorizing certain tumors or mutations as either sporadic or hereditary. The gene profiling as described herein “distinguishes” between these alternatives when the statistical probability that the change in mRNA expression level for a particular gene above or below baseline levels is due to chance alone is less than 1 percent by Chi Square analysis or 5 percent by Student's t-test.

“Estrogen Receptor status” refers to the presence or absence of estrogen receptor on the surface of cells in the tissue or tumor sample being analyzed.

“Sporadic” refers to mutations or tumors arising in breast or ovarian tissues caused by environmental or other factors that does not include those highly penetrant mutations in breast cancer predisposing genes inherited from either or both parents of the individual. Sporadic tumors may include low-penetrance genes inherited from either or both parents of the individual. Sporadic tumors may also arise as a result of DNA methylation of the BRCA1 gene or promoter or other epigenetic mechanisms.

“Hereditary” refers to those mutations present from the earliest stages of development of the individual or organism which were inherited from either or both parents, or arose de novo in an individual and can be transmitted to offspring in subsequent generations.

“BRCA1” refers to the DNA, mRNA, or translated protein of the gene identified herein as UG Rep Acc NM_{—}007295, LLID 672, and physically chromosomally located at cytoband 17q21.

“Formalin-fixed paraffin-embedded (FFPE)” refers to archival tissue samples which are initially fixed in formalin prior to being embedded in paraffin wax and allowed to cool into solids, whereby they can be maintained at room temperature for extended periods of time before being analyzed by the procedures of the method described herein including mRNA extraction and microarray analysis for the purposes of gene profiling.

### Limitations of Family History Analysis to Identify At-Risk Individuals

Identification of patients for BRCA1 and BRCA2 gene sequencing relies heavily on a clinician taking a detailed family history of cancer, then acting on this information by referring the patient for genetic counseling and genetic testing. There are several shortcomings to this approach, which are unrelated to the methods for BRCA1 and BRCA2 gene mutations. While the sensitivity of mutation analysis is high, approximately 90%, the vast majority of BRCA1 and BRCA2 mutation carriers are clinically unrecognized. These are detailed as follows.

Clinical recognition of BRCA1 and BRCA2 germline mutation status relies on family history but family history is indicative of an underlying mutation in 50% or fewer cases of female breast cancer. This is evidenced by population-based studies of women with incident breast cancer cases (Peto J et al. J Natl Cancer Inst 1999, 91:943-9; Hopper J L et al. Cancer Epidemiol Biomarkers Prey 1999, 8: 41-7; King M C et al., Science 2003, 302:643-6; de Sanjose S et al., Int J Cancer 2003, 106:588-93; Warlam-Rodenhuis C C et al. Eur J Cancer 2005; 41:1409-15, 2005). In all reported studies except that of King et al., women were stratified according to young ages at breast cancer diagnosis, further indicating the limitations of family history in identifying at-risk women.

The rate of carrier identification in the United States is 10% or less, using the following parameters: 180,000 breast cancer cases diagnosed each year, of which 5% are due to BRCA1 or BRCA2 mutations=9000 BRCA1 or BRCA2 related breast cancers per year; 10 years during which BRCA1 and BRCA2 DNA sequencing has been clinically available=90,000 BRCA1 and BRCA2 related breast cancers over the past 10 years; 13055 carriers have been identified (Martin et al., Annual Meeting of the American Society for Human Genetics, Oct. 10, 2006, abstract #371), but this includes women with and without a diagnosis of breast cancer). According to report of the first 10,000 cases (Frank T S, Deffenbaugh A M, Reid J E, Hulick M, Ward B E, Lingenfelter B et al. Clinical characteristics of individuals with germline mutations in BRCA1 and BRCA2: analysis of 10,000 individuals. J Clin Oncol 2002; 20(6):1480-1490), fewer than half (4843) of women who had gene testing had breast cancer. Thus approximately half of the 13055 carriers (2006) would be expected to have breast cancer meaning that about 6500 of a potential 90,000 BRCA1 and BRCA2 related breast cancers over the past 10 years have been identified, only 7%.

Direct tumor analysis as described herein can be used as a method to identify cases which are otherwise indiscernible using family history. Identification of carriers would not be limited by clinical parameters such as young age at breast cancer diagnosis.

### Limitation of Sample Availability for Gene Testing to Living Individuals

Gene testing of BRCA1 and BRCA2 using comprehensive mutation analysis is currently limited to DNA samples derived from blood specimens. In the vast majority of cases this means that testing is restricted to living persons (exceptions include people whose DNA was banked prior to their death, or Ashkenazi Jewish individuals whose archival tumor specimens can be subjected to limited DNA analysis). This severely limits the clinical utility of gene testing. This is because comprehensive mutation analysis within families is ideally first performed on an individual who has had breast or ovarian cancer (or both). When testing is performed in this manner, a positive result is more likely to be obtained (given autosomal dominant inheritance, unaffected individuals are about half as likely to test positive). Positive results confirm the hereditary condition in the family and also provide for clear cut results in relatives subsequently testing (true positive or true negative). Because the test sensitivity of BRCA1 and BRCA2 comprehensive mutation analysis is less than 100% and because genes other than BRCA1 and BRCA2 cause breast cancer, a negative result is uninformative until a positive result has been observed within a family. Thus, interpretable results often hinge on the availability of a blood specimen from an affected individual. However such individuals have often died due to the aggressive nature of breast and ovarian cancer. By extending the analysis to archival tumor specimens, the availability of genetic testing in families is enhanced.

Targeting Gene Testing to Those Likely to have Mutations; Reducing Cost of Gene Testing

The sensitivity of gene testing in women with breast cancer using traditional comprehensive mutation analysis methods can be enhanced by using gene expression profiling of breast tumors. According to Frank et al. (Frank T S, Deffenbaugh A M, Reid J E, Hulick M, Ward B E, Lingenfelter B et al. Clinical characteristics of individuals with germline mutations in BRCA1 and BRCA2: analysis of 10,000 individuals. J Clin Oncol 2002; 20(6):1480-14902002) only 20% of women with a history of breast cancer who undergo comprehensive mutation analysis have identifiable BRCA1 or BRCA2 mutations. This is a costly approach since each comprehensive analysis costs about $3000, with a corresponding cost of $15,000 to identify a single mutation carrier. By using gene expression profiling as a pre-screen, comprehensive mutation analysis could then be targeted to women whose breast cancers have a high (80-90%) likelihood of being due to an underlying germline mutation. Furthermore, comprehensive mutation analysis could be restricted to the gene in question (e.g. BRCA1 only as opposed to both BRCA1 and BRCA2), further reducing costs. Once a mutation is detected, then genetic testing in blood relatives is enhanced in that the cost is less (˜$400) because single-site analysis can be done, and the accuracy approaches 100% for both positive and negative results.

Utility of Identifying Patients whose Breast Tumors are Not Due to BRCA1 Mutations

Patients whose tumors have a BRCA1 gene expression pattern can be tested for BRCA1 only. If a mutation is not identified, these patients can become the subject of additional research studies. Underlying possibilities include a missed mutation; using specimens from these patients new methods for detecting underlying mutations can be developed. Another possibility is that other inherited genes are involved which are likely either upstream or downstream of the BRCA1 gene; these patients and their families can become the subject of linkage analysis and other methods to identify novel cancer predisposing genes. Alternatively, these patients may have somatic (acquired) mutations, the biology of which can be further explored given implications for targeted treatment and possibly worse prognosis.

### Functional Assay; Clarification of Variants

Genetic testing of most hereditary cancer genes is hampered by the high prevalence of variants of uncertain significance. These are DNA sequence variants which may or may not compromise the function of the gene, but for which there is insufficient information to characterize their clinical function. In the case of BRCA1 and BRCA2, variants of uncertain clinical significance comprise about 7% of test results.

Epidemiological and biological criteria can be applied to distinguish functional from benign variants with some success (Deffenbaugh A M, Frank T S, Hoffman M, Cannon-Albright L, Neuhausen S L. Characterization of common BRCA1 and BRCA2 variants. Genet Test 2002; 6(2):119-121). For example, the prevalence of each variant in a control population, co-segregation of the variant with cancer within families, location of the variant within the gene, functional assays, demonstration of abnormal mRNA transcript processing, type of the amino acid substitution and degree of conservation among species (Fleming M A, Potter J D, Ramirez C J, Ostrander G K, Ostrander E A. Understanding missense mutations in the BRCA1 gene: an evolutionary approach. Proc Natl Acad Sci USA 2003; 100(3):1151-1156) provide clues as to whether the mutation is deleterious (Frank T S, Deffenbaugh A M, Reid J E, Hulick M, Ward B E, Lingenfelter B et al. Clinical characteristics of individuals with germline mutations in BRCA1 and BRCA2: analysis of 10,000 individuals. J Clin Oncol 2002; 20(6):1480-1490). Genetic counseling for variants of uncertain clinical significance is a commonly encountered and highly problematic issue (Petrucelli N, Lazebnik N, Huelsman K M, Lazebnik R S. Clinical interpretation and recommendations for patients with a variant of uncertain significance in BRCA1 or BRCA2: a survey of genetic counseling practice. Genet Test 2002; 6(2):107-113), which can possibly lead to the inappropriate use of medical interventions such as prophylactic surgery (Lynch H T, Snyder C L, Lynch J F, Riley B D, Rubinstein W S. Hereditary breast-ovarian cancer at the bedside: role of the medical oncologist. J Clin Oncol 2003; 21(4):740-753).

A functional assay would enhance classification into benign and deleterious mutations and aid in clinical interpretation. Gene expression profiling can be used as a functional assay to help define the clinical significance of variants. The present invention provides methods for analyzing and classifying mutations in genes that are individually linked to BRCA1 function and collectively provide a profile of such function from formalin-fixed, paraffin-embedded archival tissue samples.

### Targeted Therapies; Personalized Medicine

There is an opportunity for targeted treatment of germline-mutated BRCA1 breast cancers and the 15-30% of sporadic breast cancer with somatic inactivation of BRCA1 by mechanisms including DNA methylation or other epigenetic events. Breast tumors with loss of function of BRCA1 or BRCA2 are uniquely sensitive to PARP [Poly(ADP-ribose) polymerase] inhibitors due to underlying defect in DNA double-stranded break repair.

Need to Identify Patients as having BRCA1 Loss of Function in a Timely Manner

In order to provide targeted treatments, it will be crucial to identify patients with breast tumors that have BRCA1 loss of function at the time of diagnosis in order to provide targeted treatment. Comprehensive BRCA1/2 testing has a routine turn-around time of 3-4 weeks which may be too long for a timely diagnosis of inherited loss of BRCA1 function. While a rapid turn around time (7-10 business days) test is available the cost is an additional $1500, which is not borne by insurance. Gene testing will not identify somatic (acquired) loss of BRCA1 function. Therefore a rapid, pre-screen will be highly useful for identifying breast tumors with BRCA1 loss of function in a timely manner in order to use this information to guide targeted treatments.

### Chemoprevention

Prevention of breast cancer in women at high risk can be accomplished by identifying women with breast cancer risk factors and instituting treatment. Several chemoprevention trials have been conducted which have demonstrated the preventive efficacy of selective estrogen receptor modulators (SERMs) such as tamoxifen and raloxifene. These agents have been FDA approved for breast cancer chemoprevention in high-risk women. While SERM treatment results in a ˜50% reduction in breast cancer risk, these agents are not tailored to the underlying risk factors in individual women. Agents with higher efficacy and lower toxicity are desirable. Furthermore, there is uncertainly as to whether SERMs are effective in BRCA1 mutation carriers, because SERMS are effective in the prevention of estrogen receptor positive breast cancers, but the majority (80-90%) of BRCA1 associated breast cancers are estrogen receptor negative.

BRCA1 mutation carriers have one wild-type allele and one mutated allele in each cell. If the wild-type allele is lost (e.g. through mutation or epigenetic modification, perhaps due to carcinogenic exposures) then the cell in which this occurs acquires a defect in DNA DS break repair. Subsequent mutational events lead to a clinically detectable cancer. The biological progression from a single cell with two hits in BRCA1 (germline and somatically acquired hits in each allele) to clinically detectable cancer represents an ideal time in which to institute chemopreventive treatments. PARP inhibitors may provide an ideal chemopreventive treatment for BRCA1 mutation carriers because the agents are specifically targeted to the underlying defect, have a high therapeutic index (high efficacy against disease coupled with low toxicity to non-cancerous cells), and can eliminate the very first cell that arises in the cancer progression pathway.

PARP inhibitors are now in use in clinical trials in combination with cytotoxic drugs (Jagtap P, Szabo C. Poly(ADP-ribose) polymerase and the therapeutic effects of its inhibitors. Nat Rev Drug Discov 2005; 4(5):421-440). Clinical trials using PARP inhibitors for BRCA carriers have been discussed in the literature (Tutt A N, Lord C J, McCabe N et al. Exploiting the DNA repair defect in BRCA mutant cells in the design of new therapeutic strategies for cancer. Cold Spring Harb Symp Quant Biol 2005; 70:139-148). The 2007 American Society of Clinical Oncology meeting June, 2007, Chicago, Ill.) included a report of phase I study of PARP inhibitors.

Gene expression profiling would be useful in at least two chemoprevention scenarios for BRCA1 mutation carriers. First, women who have had already had breast cancer because of an underlying BRCA1 mutation are at very high risk of another breast cancer, about 40% during the first ten years following an initial diagnosis of breast cancer. Performing gene expression profiling on their tumors, and confirming the presence of an inherited BRCA1 mutation through gene testing, would make possible the use of a selective chemoprevention agent such as a PARP inhibitor. Chemoprevention agents that are not known to be targeted to BRCA1 breast cancers, such as SERMs, may also be utilized for treatment. Because BRCA1 mutation carriers have a high incidence of bilateral breast cancer, chemoprevention of a second breast malignancy would be an important addition to the armamentarium of treatments.

Second, by identifying probands with BRCA1 mutations using gene expression profiling, unaffected relatives can be identified and chemoprevention instituted in them prior to the development of a primary breast cancer. Chemoprevention may include agents that are targeted to BRCA1 mutations carriers, such as PARP inhibitors, or agents such as SERMs.

### Breast Cancer Stem Cell Biology

Gene expression profiling of tumors with BRCA1 loss of function can be used to shed light on breast cancer stem cell biology. Foulkes and others have advanced a hypothesis that BRCA1 functions as a breast stem cell regulator. The cancer stem cell theory posits that a self-replenishing pool of stem cells gives rise to cancer and that cancer treatments may leave part of this pool untouched, serving as a source for cancer recurrence. Identifying BRCA1 breast tumors using gene expression profiling and studying these tumors may be useful in order to develop experimental models of stem cell regulation and improved therapies. The specific genes which define the BRCA1 profile are over-represented by genes involved in stem cell regulation in a variety of tissues. These may serve as targets for early detection assays of breast cancer as well as therapeutic targets. See Foulkes W D, BRCA1 functions as a breast stem cell regulator. J Med Genet, 2004, 41:1-5.

### EXAMPLES

### Example 1

### Samples and RNA Preparation

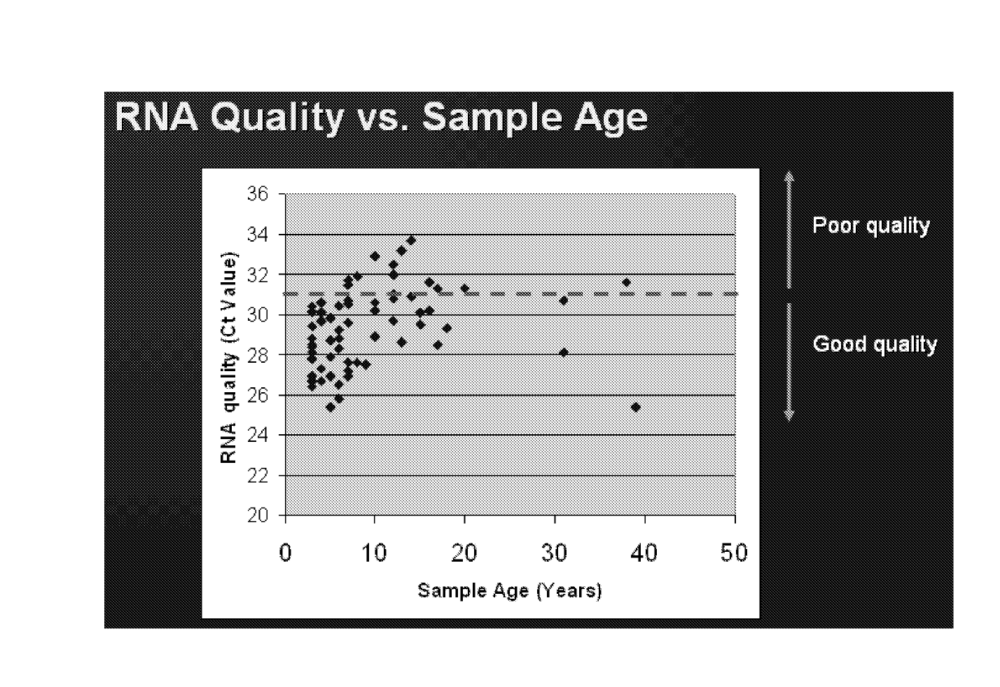

Formalin-fixed, paraffin embedded (FFPE) tissue blocks were retrieved from the pathology archives bank of Evanston Northwestern Healthcare (Evanston, Ill.), Department of Pathology in accordance with HIPAA and Institutional Review Board (IRB) guidelines. Total RNA was prepared from the FFPE breast tumor blocks using the High Pure RNA Paraffin Kit (Roche Applied Science, Indianapolis, Ind.). All chosen blocks contain more than 50% tumor. The relationship of RNA quality versus the age of the archival sample is illustrated in FIG. 4. As the data indicates, the age of the archival material is not predictive of sample quality. The oldest sample in the study (39 years) demonstrates one of the highest quality RNAs

### Example 2

### Microarray Analysis and DASL™ RNA Pre-Qualification

RNA extractions were pre-qualified for the DASL™ assay by a real-time PCR assay recommended by Illumina Inc. (Illumina: Gene Expression on Sentrix Arrays: DASL Assay System Manual, Doc # 11175105 edn: Illumina Inc 2004). RNA (200 ng) was reverse-transcribed into cDNA using the Master Mix for cDNA synthesis, single use reagent (Illumina, San Diego, Calif.). The rtPCR reactions were performed on an ABI Prism 7900HT Real Time System (Applied Biosystems, Foster City, Calif.) using a Platinum® SYBR® Green qPCR superMix-UDG with Rox (Invitrogen, Carlsbad, Calif.) with the recommended PCR program and primers [1] to yield a 90 by transcript-specific fragment of the highly expressed RPL13a ribosomal protein gene (GenBank accession # NM_{—}012423.2).

### Example 3

### DASL™ Gene Expression

In the DASL™ assay total RNA is converted into cDNA using a reverse transcription reaction using random hexamers and is then labeled with biotinylated oligos (b(N)₉ and b(T)₁₈). Pairs of query oligonucleotides are annealed to complementary sequences (˜50 bases) flanking specified cDNA target sites. The biotinylated cDNA is then bound to streptadadivin particles and washed to eliminate mis and non-hybridized particles. A primer extension and ligation process then forms a biotinylated (˜100 bp) DASL product containing a unique address sequence for a specific gene. This product is then amplified using conditions detailed in [1] and two of three universal primers to produce a fluorescently labeled amplicon for hybridization. The two upstream primers are 5′ labeled with Cy3 and Cy 5 respectively while a downstream primer is biotinylated for capture and elution of the PCR product. The use of two dyes results in two separate measurements of a transcripts population and thus increases statistical power.

Labeled amplicons are hybridized to a BeadChip or a Sentrix Array Matrix in an oven overnight while cooling from 60 to 45 degrees Celsius. The arrays consist of etched pits populated by silica beads with complimentary unique address codes. Each array contains about 50,000 3 μm silica bead which results in each unique address or bead type (1536) being present about 30 times per array. The beads are positioned randomly, and a decoding procedure is used to identify the location and DNA sequence on each bead (Oliphant A, Barker D L, Stuelpnagel J R, Chee M S: BeadArray technology: enabling an accurate, cost-effective approach to high-throughput genotyping Biotechniques 2002, (Suppl):56-58). After hybridization, the array is then scanned by laser confocal microscopy using an automated BeadStation™ Reader and SentrixScan™ software from Illumina. The software creates an intensity data file which is used in statistical analysis of the results.

### Example 4

### Procedures for BRCA1 Promoter Methylation

DNA methylation analysis of the BRCA1 promoter was performed to investigate the basis for reduced expression in the absence of gene mutation. One 5 μm tissue section was cut from each FFPE block and DNA was isolated using the PUREGENE DNA Purification Kit (Gentra System, Minneapolis, Minn.). PCR amplification of a 223 by human DNA target was performed to assess DNA quality, which was good in all cases. DNA samples were then bisulfite treated using EZ DNA Methylation-Gold kit (Zymo Research Corp., Orange, Calif.). We used CpGenome Universal Methylated DNA (CHEMICON International Inc., Temecula, Calif.) as positive control and a normal sample as negative control. BRCA1 methylation status was determined by methylation-specific PCR. Primer sequences (3272bp-3360bp) were 5′-gAgAggTTgTTgTTTAgCggTAgTT (forward) and 5′-CgCgCAATCgCAATTTTAAT (reverse) and probe oligo sequence was 5′-6FAM-CCgCgCTTTTCCgTTACCACgA-TMR (Widschwendter M, Cancer Res 2004; 64: 3807-3813). Methylation-specific PCR was carried out in 20 ul reaction volumes on a Roche Lightcycler (Roche Applied Science) for 50 cycles (10 s at 95° C., 30 s at 64° C., 20 s at 72° C.).

### Example 5

### Quantitative RT-PCR

To further confirm our microarray data, we performed qRT-PCR on three genes showing differential expression. Total RNA was prepared from the FFPE breast tumor blocks using the High Pure RNA Paraffin Kit (Roche Applied Science) and converted to cDNA using RT² PCR Array First Strand Kit (SuperArray Bioscience Corporation, Frederick, Md.). A total of 500 ng tRNA for each sample was used to prepare cDNA according to the manufacturer's instructions. Human Universal Total RNA (SuperArray Bioscience Corporation) was used as a positive control, and for construction of standard curves to quantify each gene. The primers for MAGEA4, SPIB, BRCA2, and GAPDH (used as a housekeeping gene for normalization) were obtained from SuperArray Bioscience Corporation.

RT-PCR was performed in 20 ul reaction volumes on a Roche Lightcycler (Roche Applied Science) with amplification for 50 cycles (30 s at 95° C., 30 s at 55° C., 30 s at 72° C.). Each reaction was subjected to melting point analysis to confirm single amplified products.

### Example 6

### Adaptation of Gene Expression Profiling of BRCA1 Breast Tumors to Archival Materials

Fresh frozen tissue is the specimen type used in all prior art in BRCA1 gene expression profiling. Limited numbers of fresh frozen tissue specimens are available for BRCA1 research studies and virtually none are available for clinical use. This is because pathology laboratories prepare and archive tumors in the form of formalin-fixed, paraffin-embedded (FFPE) tissues. A vast number of such specimens exist in clinical pathology laboratories across the United States and around the world, which are usually stored for a decade or longer.

The Illumina DASL (cDNA-mediated annealing, selection, extension and ligation) assay is designed to generate reproducible profiles from degraded RNAs, for example FFPE archival specimens. We selected a select limited number of target genes for custom array. Each gene represented by 3 oligonucleotide probes. Each probe is represented by approximately 30 beads.

Sample prequalification was done using RT-PCR of a housekeeping gene. Most samples were 1-2 decades old; some were 3-4 decades old.

### The Design of the 128-Gene DASL Array

As a first step in designing the array, we performed an extensive literature search on BRCA1-related breast tumor studies. Many of such studies involve DNA microarrays and various gene lists that related to BRCA1. The compiled list includes 354 unique genes.

We further selected 721 genes that are differentially expressed BRCA1-mutated tumors according to our own DNA microarray data. A pooled RNA sample representing BRCA1-mutated breast tumors and another pooled sample representing sporadic tumors were hybridized three times to Affymetrix U133 Plus 2.0 array. We observed that 21 genes are common to this list and the list from literature review. Two genes/ESTs (BQ707388 and AL137761) could not be mapped to RefSeq using http://david.abcc.ncifcrf.gov/ and were not used in the final array. Thus, 19 of these 21 genes are included in our array.

We retrieved the expression data on literature-based gene list from the microarray data of van t' Veer et al (Nature 2000) that covers BRCA1-mutated (20 samples) and sporadic breast tumors (96 samples). Similar data is also retrieved from our own DNA microarray data based on pooled samples of mutated and sporadic breast tumors. We then ranked these genes by their correlation with the BRCA1 vs. sporadic distinction. A correlation coefficient is calculated by, where μ₁ and σ₁ are the mean and standard deviation of the expression level in BRCA1 mutated samples, μ₂ and σ₂ are corresponding parameters for sporadic samples (Golub et al., Molecular classification of cancer: class discovery and class prediction by gene expression monitoring. Science 1999 Oct. 15, 286:531-7). Genes are ranked according to this parameter. We selected based on the average of the percentile from both datasets. We selected 31 genes that are highly expressed in BRCA1-mutated tumors and 30 genes highly expressed in sporadic tumors. Of the 31 genes that are highly expressed in BRCA1 mutated tumors, one (AK126320) could not be mapped to RefSeq using http://david.abcc.ncifcrf.gov/ and was not used in the final array. Of the 30 genes that are highly expressed in sporadic tumors, one (AK096661) could not be mapped to RefSeq using http://david.abcc.ncifcrf.gov and was not used in the final array.

A total of four gene substitutions were made based on inability to map genes/ESTs (BQ707388, AL137761, AK126320, AK096661) to RefSeq. The following genes were substituted in lieu of these gene/ESTs: COX6C and PDGFB (both highly expressed in BRCA1-mutated tumors) and TOPBP1 and MCM7 (both highly expressed in sporadic tumors).

Two of the 30 genes that are highly expressed in sporadic tumors had a low predicted probability of success on the array according to the probe design analysis performed by Illumina, Inc. These two genes, PRSS2 and DKF2p434E2321 were not used in the final array. Two gene substitutions were used, PDGFRB and CD36, both of which were also highly expressed in sporadic tumors.

To overcome the limit of the literature reported genes, we also included the top 10 genes that are highly expressed in BRCA1 mutated tumors and top 10 genes lowly expressed in such tumors (which corresponds to “high in sporadic”) according to our own expression data. For the “top 10 genes that are highly expressed in BRCA1 mutated tumors”, one (FABP7) was also included in the “overlapping 21 genes” category leaving 9 independent genes in this category.

Another 20 genes are selected based on their biological relevance with BRCA1-mutated breast tumors. Such genes include the genes like BRCA1 and BRCA2, and also various keratin genes that are known to be important in distinguishing different types of breast tumors. Of these 20, 19 are noted independently of the other selection criteria; 1 (ESR1) overlaps with “overlapping 21 genes”.

For quality control purposes, we included the following 5 housekeeping genes as positive controls: ACTB, GAPD, EIF4G2, SRRM1, and KHDRBS1. Two of them (ACTB and GAPD) are highly expressed, and the other three (EIF4G2, SRRM1 and KHDRBS1) are expressed at moderate levels. Furthermore, we included 3 genes as negative controls that are not expected to be expressed in breast tissues. Such genes include a brain-specific gene (MAG), a liver-specific gene (CFHL5), and a colon-specific gene (CEACAM1).

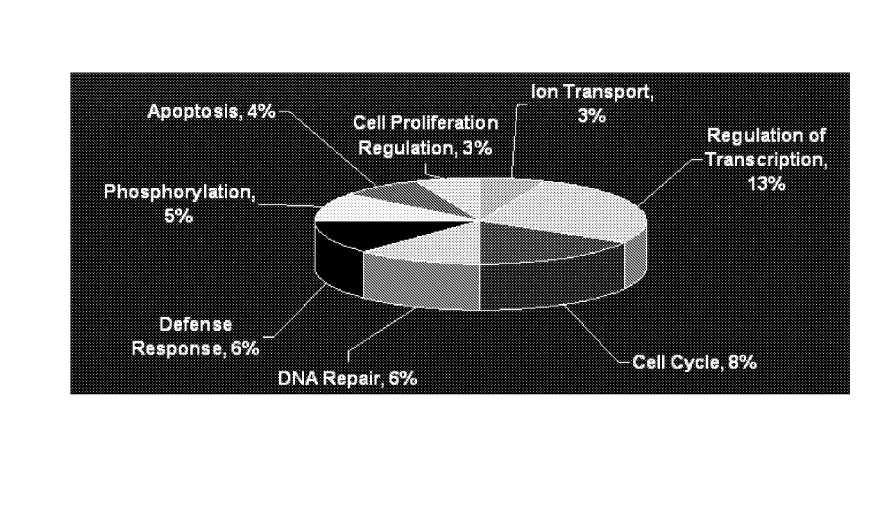

These selections gave a final total of 128 genes for the custom array, which are detailed in TABLE 3 and TABLE 4. The distribution of genes selected for the custom array fall broadly into several functional categories, with particular weighting towards transcriptional regulation, cell cycle control, and DNA repair (FIG. 5).

### Example 7

### Confirmatory Studies

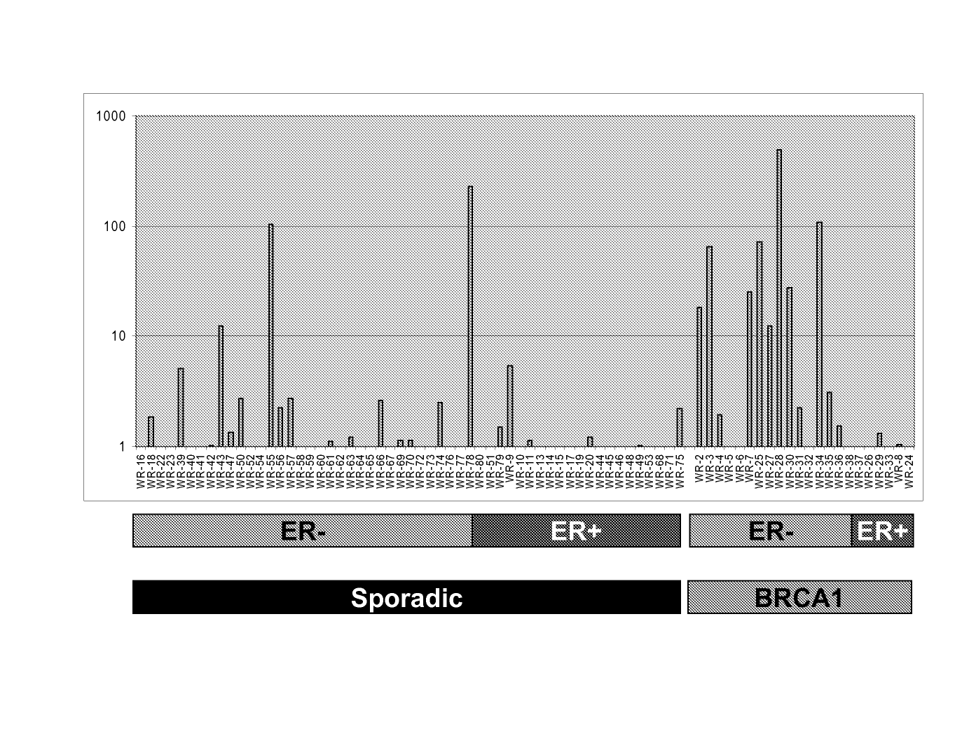

Quantitative real-time PCR was performed for three genes (MAGEA4, SPIB, BRCA2) to confirm gene expression found on microarray analyses. MAGEA4 (melanoma antigen family A, 4) was selected for analysis based on its extremely high expression (greater than 10 fold) in 50% of the BRCA1⁺, ER⁻ tumors (FIG. 6). MAGEA4 is a tumor antigen that is known to be related with other cancer types (e.g. germ cell tumors, malignant melanomas, certain carcinomas and sarcomas).

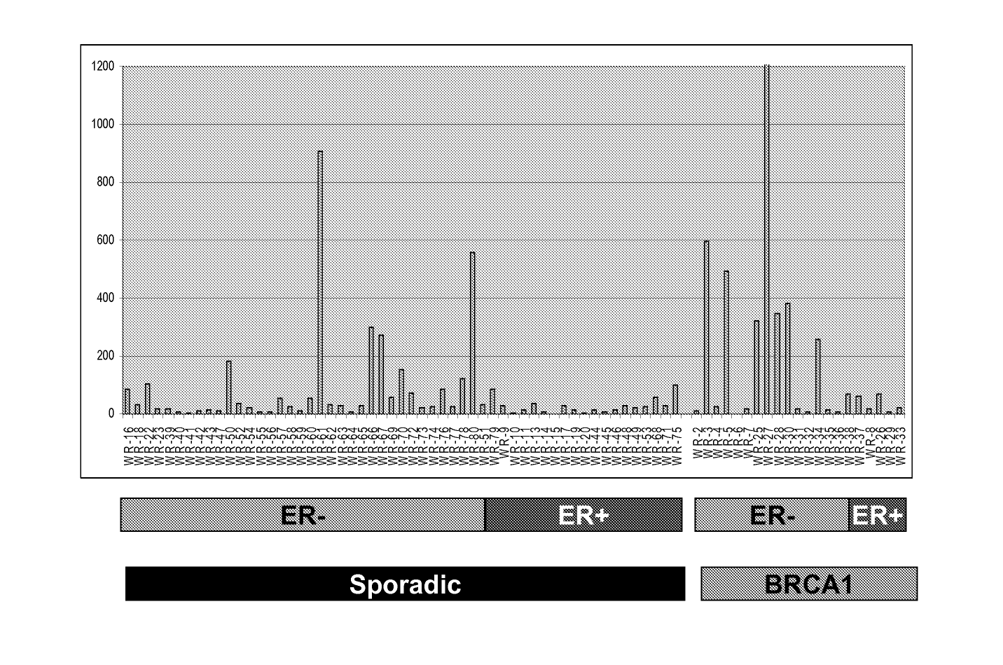

SPIB (Spi-B transcription factor) was selected for analysis based on its high fold change (2.5×) in BRCA1 mutated vs. sporadic breast cancers and its independence from estrogen receptor status (FIG. 7). SPIB is involved in the control of plasmacytoid dendritic cells development by limiting the capacity of progenitor cells to develop into other lymphoid lineages.

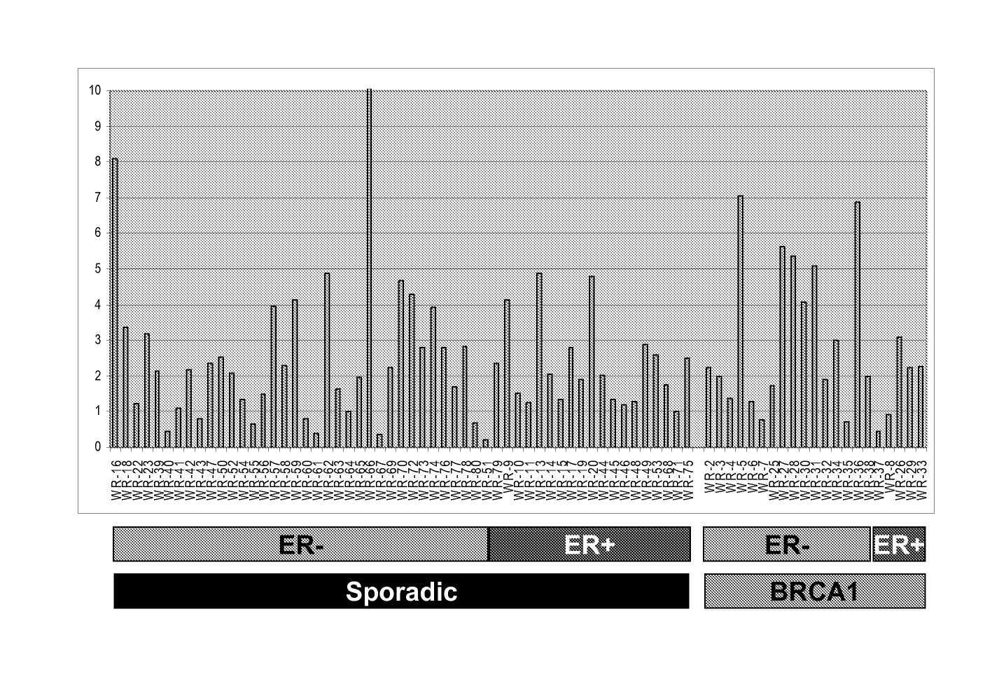

BRCA2 (breast cancer 2, early onset) was selected based on biological interest. Differential expression of BRCA2 was significant, but not high (1.6 fold, see FIG. 8). BRCA2 gene expression correlates with ER status (higher expression in ER⁻ breast tumors). BRCA2 germline mutations cause a very similar clinical syndrome compared to BRCA1, and genetic testing usually involves both genes. The biological characteristics of germline BRCA2-mutated breast cancers are distinct from germline BRCA1-mutated breast cancers. The scientific literature has not previously suggested coordinate regulation of these two genes.

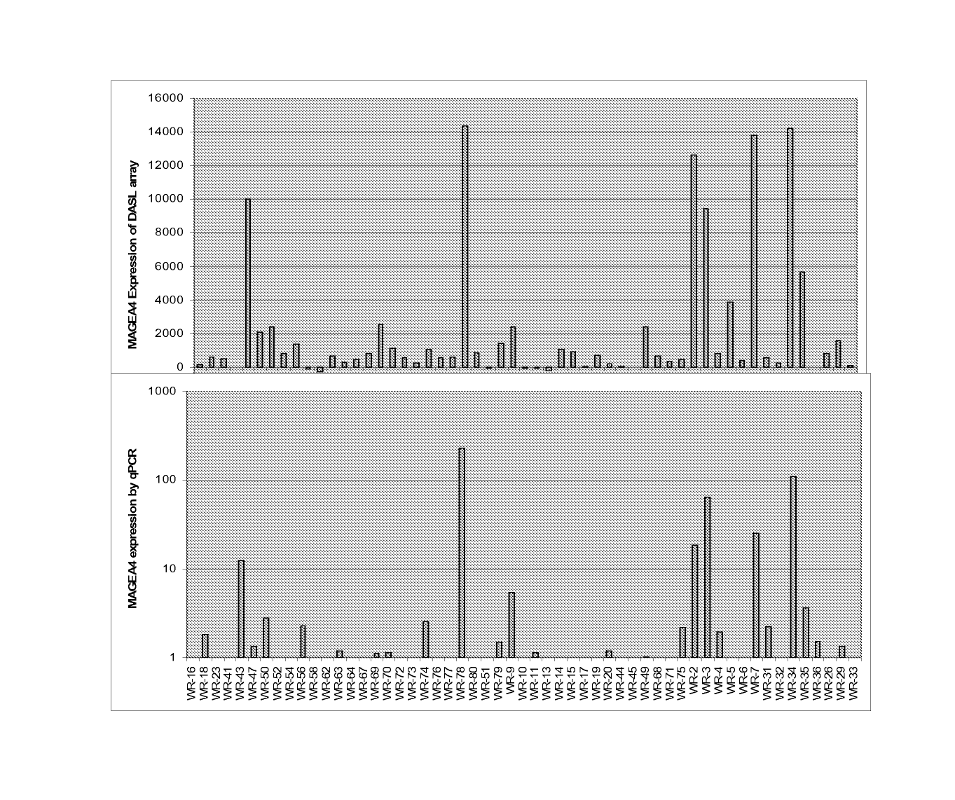

MAGEA4 gene expression as measured by qPCR was highly correlated with MAGEA4 gene expression as measured by DASL array as indicated in FIG. 9 (P value for sporadic vs. BRCA1: P<0.0054 by Wilcoxon rank sum test with continuity correction).

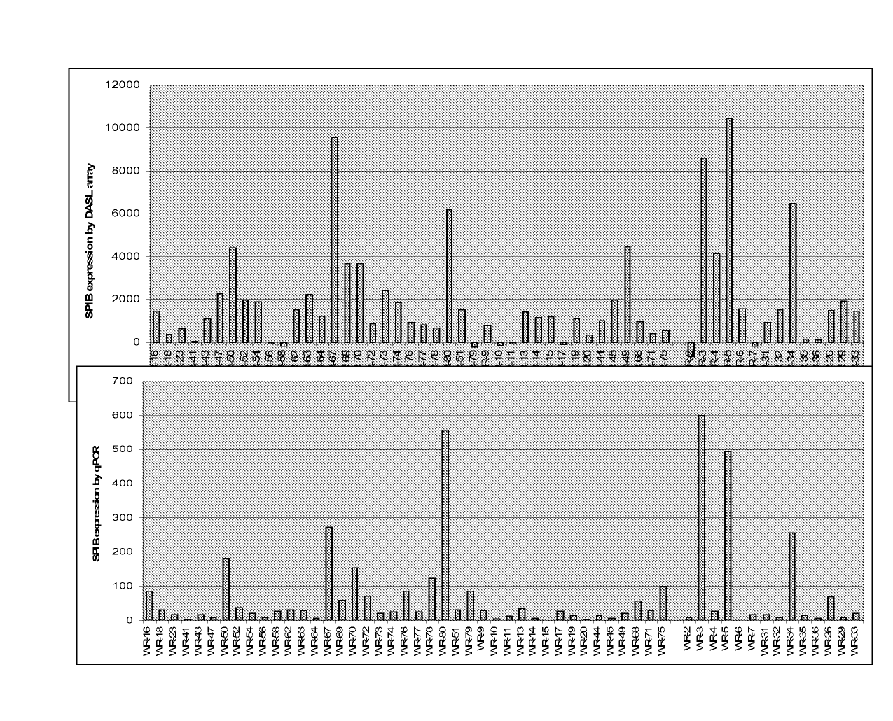

As illustrated in FIG. 10, SPIB gene expression as measured by qPCR was highly correlated with SPIB gene expression as measured by DASL array (Student T-test P value<0.024. ER+ vs ER−: Wilcoxon test P<0.05).

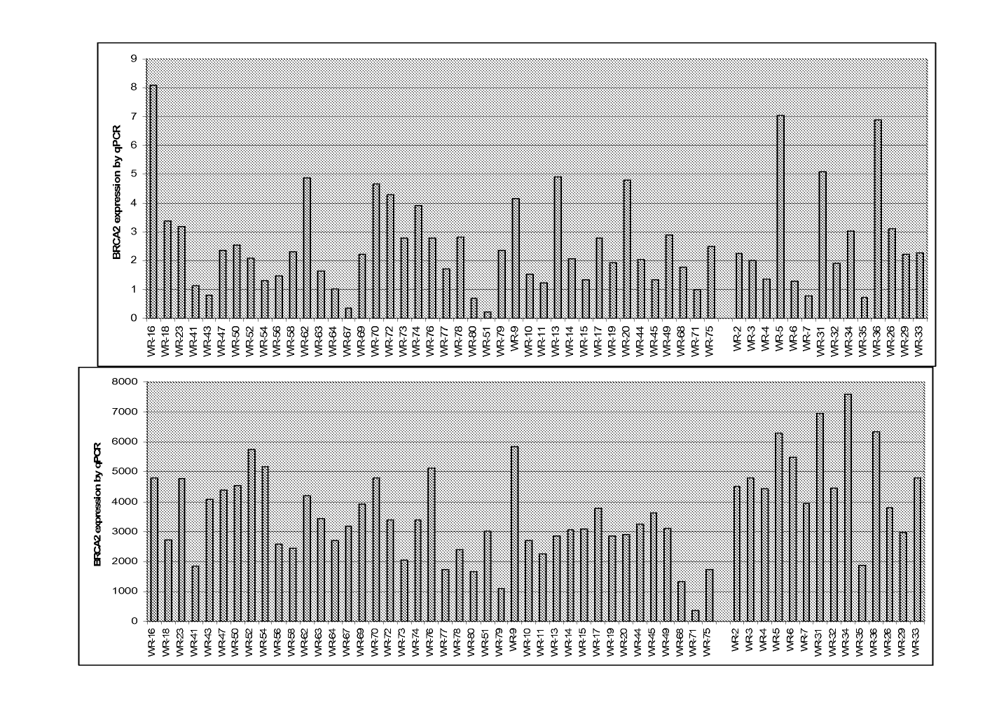

BRCA2 expression, contrary to the confirmatory studies performed on MAGEA4 and SPIB, did not show a statistically significant correlation between the DASL expression results and the qPCR data (FIG. 11, sporadic vs BRCA1+: Wilcoxon test P<0.48, not significant. T-test also not significant). The low degree of differential expression between the sporadic and BRCA1+ samples and the lack of statistical correlation call into question whether the two BRCA2 probes are spuriously correlated with BRCA1 germline mutation status. For genes with high-fold expression (MAGEA4 and SPIB), qPCR and DASL expression results are highly correlated, confirming the reliability of DASL gene expression results.

### Example 8

### Data Acquisition

### A. Visualization

Raw image data is processed with Illumina's BeadStudio Version 1.5 to summarize gene expression in terms of a signal and a detection score. The detection score was calculated by comparing a signal produced by a probe with these produced by negative control probes, modeled by a normal distribution. A detection score>0.99, equivalent to P value<0.01, was used as a threshold for detected probes.

### B. Quality Control

Microarray data was first subjected to a quality control process. Samples with less than 50% detected probes were removed from further analysis. These samples tend to have high background levels. We eliminated 10 out of 83 samples. The qualified 73 samples were divided into a training dataset of 43 samples and an independent testing dataset of 30 samples. The training dataset contains 21 BRCA1+samples (7 ER+, 14 ER−) and 22 sporadic samples (8 ER+, 14 ER−). The same ER+ to ER− ratio is maintained in this training dataset in both BRCA1+ and sporadic groups to avoid possible biases. Sporadic samples that are hyper-methylated in the BRCA1 promoter were also excluded from training dataset.

### C. Normalization

A background normalization method provided in BeadStudio software (Illumina: Gene Expression on Sentrix Arrays: DASL Assay System Manual. Doc No. 11175105 edn: Illumina, Inc. 2004) was used to subtract a constant background value from all expression values. To further reduce intra-chip variability, all-vs.-all LOESS normalization was performed using the “affy” package in Bioconductor (Oliphant A, Barker D L, Stuelpnagel J R, Chee M S. BeadArray technology: enabling an accurate, cost-effective approach to high-throughput genotyping. Biotechniques (Suppl.) 56-58, 2004). Parameters were normalize.loess (data, epsilon=1, log.it=F, span=0.4, maxit=2), where data is our data matrix.

### D. Gene Selection

Log-transformed data was used to perform a student t-test to select differentially expressed genes in BRCA1+ samples. Probes were selected if it has a P value<0.01 and shows a minimal fold-change of 1.20. Probes more strongly associated with ER status, as indicated by P value, were excluded.

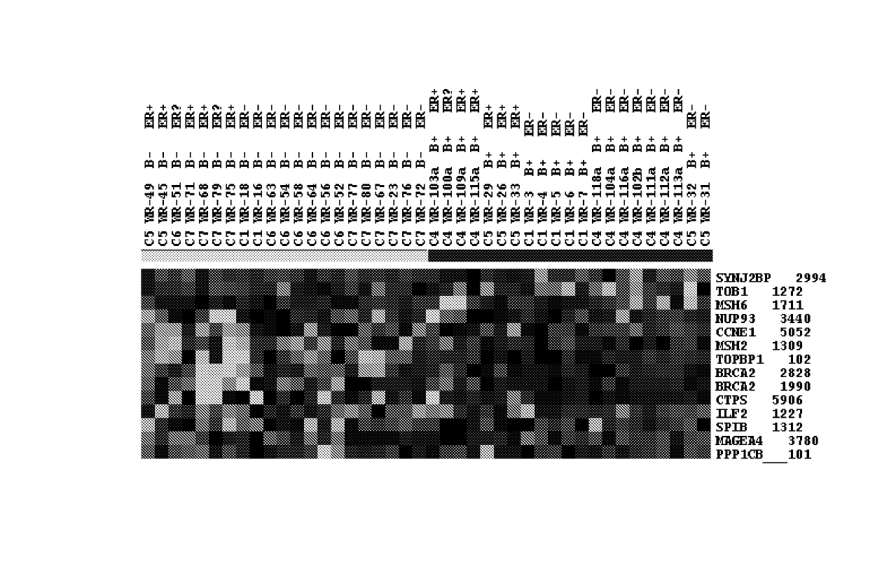

We selected 14 probes representing 13 genes (FIG. 2). Two probes of BRCA2 genes were included in this list, suggesting that this gene's association is robust. Gene Ontology analysis using DAVID (Database for Annotation, Visualization, and Integrated Discovery, see Dennis G Jr, Sherman B T, Hosack D A, Yang J, Gao W, Lane H C, Lempicki R A. DAVID: Database for Annotation, Visualization, and Integrated Discovery. Genome Biol. 2003; 4(5):P3) revealed that this list is enriched (P<0.0003) with DNA repair related genes. Four genes in this list (MSH2, MSH6, TOPBP1 and BRCA2) are related to DNA repair.

E. Supervised Classification of Independent Dataset

Based on the selected genes and the training dataset, an independent dataset was classified using k-nearest neighbor algorithm (KNN). Samples in both training and testing datasets are further normalized to have a mean of zero and standard deviation of 1. Weighted votes from six most similar samples are used to predict the class membership of a testing sample. If vote from two classes are close (difference less than 30%), no prediction will be made.

The algorithm correctly predicted the class membership (BRCA1+ or sporadic) of 25 (83.3%) out of 30 testing samples. Nine out of 11 BRCA1+ samples are consistently classified, equivalent to a sensitivity of 81.8%. Two out of 11 predicted BRCA1+ samples are false positives, leading to a specificity of 81.8%.

Leave-one-out cross validation was carried out by withholding one sample each time and select predictor genes to make predictions of the withheld sample. We observed an overall accuracy of 72%.

### F. Reproducibility—Technical Replicates

Technical replicates for 7 RNA samples were hybridized twice to test the reproducibility of the platform. We observed an average Pearson's correlation coefficient of R=0.851.

### Example 9

### Methylation Studies

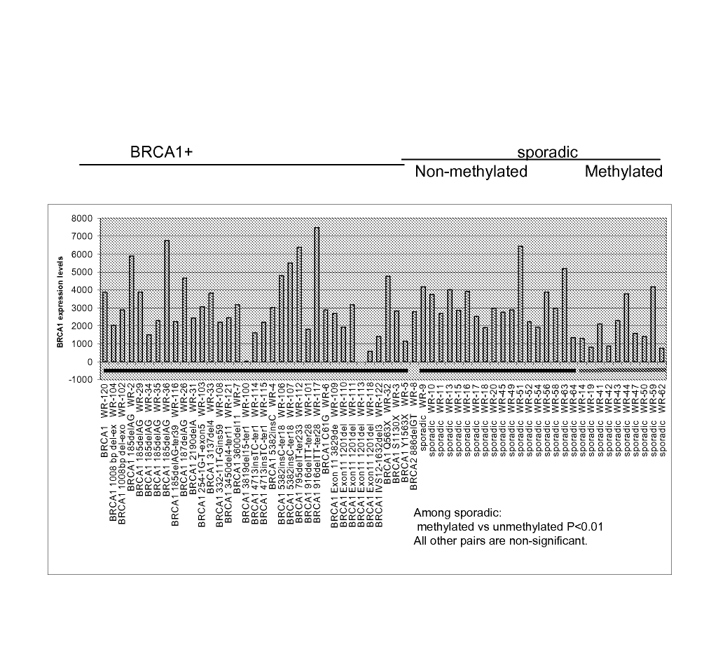

DNA methylation of the BRCA1 promoter was observed in 10 of 28 (36%) sporadic breast cancers and 2 of 20 (10%) BRCA1 germline-mutated breast cancers. BRCA1 expression was analyzed with respect to DNA methylation status of the BRCA1 promoter for sporadic breast tumors (FIG. 3). BRCA1 expression levels were inversely correlated with methylation of the BRCA1 promoter (P<0.01).

Our results confirm previous reports that BRCA1 promoter methylation serves as a basis for reduced expression in the absence of gene mutation. We found a high level of BRCA1 methylation among sporadic breast tumors (36%) as compared with 15-30% reported in the literature. One implication of epigenetic BRCA1 modification would be that BRCA1-like sporadic breast cancers may be “misclassified” as BRCA1 germline-mutated, and could comprise a proportion of samples coded as false positive on the classifier. If classifier results were used to guide selection of patients for germline BRCA1 mutations analysis, this would be a source of negative germline sequence results.

Therefore we assessed whether false positive specimens, i.e. sporadic breast tumors that were misclassified as BRCA1 germline-mutated, were DNA methylated at the BRCA1 promoter. Neither of the two misclassified specimens demonstrated BRCA1 promoter methylation. We conclude that for our specimens, BRCA1 promoter methylation did not contribute to the imperfect specificity of the classifier. However, since BRCA1 promoter methylation has previously been shown to be associated with false positive misclassification in a gene expression profiling study (Hedenfalk et al. Gene-expression profiles in hereditary breast cancer. N Engl J Med 2001; 344(8):539-548), we hypothesize that BRCA1 promoter methylation can occur as an early or a late event in tumorigenesis, with different effects on tumor biology. We further hypothesize that if BRCA1 methylation occurs early during tumorigenesis, it may be an etiologic factor that influences downstream events and leads to a BRCA1-like phenotype. In these sporadic breast tumors, the BRCA1 expression profile would parallel that of BRCA1 germline-mutated tumors. If the underlying biology of sporadic BRCA1-like and germline-mutated BRCA1 breast tumors are similar, then targeted therapies may be valuable for not only BRCA1 germline mutated breast cancers, but also the larger population of sporadic BRCA1-like breast cancers. This has important implications as targeted therapies (e.g. PARP inhibitors) are now in phase II trials for patients with germline BRCA1 mutated cancers. If these therapies are effective, they may also be applicable to the 15-30% of women with BRCA1-like breast cancers.

Our data also report for the first time on the methylation status of germline mutated BRCA1 breast tumors, showing BRCA1 promoter methylation of 10% of specimens. BRCA1 promoter methylation in germline-mutated tumors may serve as a second hit to silence BRCA1 express

1. A method for identifying BRCA1 mutations in breast and ovarian cancer tissue comprising the use of gene expression profiles or patterns from archival formalin-fixed paraffin-embedded (FFPE) specimens using a DNA array.

2. The method of claim 1, wherein said gene profiling distinguishes between sporadic and hereditary types of breast and ovarian cancer.

3. The method of claim 1, wherein said method is independent of estrogen receptor (ER) status of the tissue.

4. The method of claim 1, wherein the gene profiling is selected from a group of 128 selected genes as reflected in TABLE 4.

5. The method of claim 1, wherein the DNA array is a DASL array.

6. The method of claim 1, wherein the sensitivity of detecting BRCA1 mutations by using said gene profiling method is greater than 50%, and still further wherein the specificity for correctly classifying BRCA1 mutations of said gene profiling method is equal to or greater than 60%.

7. The method of claim 1, wherein the sensitivity of detecting BRCA1 mutations by using said gene profiling method is greater than 80%, and still further wherein the specificity for correctly classifying BRCA1 mutations of said gene profiling method is equal to or greater than 70%.

8. The method of claim 1, wherein the sensitivity of detecting BRCA1 mutations by using said gene profiling method is greater than 90%, and still further wherein the specificity for correctly classifying BRCA1 mutations of said gene profiling method is equal to or greater than 80%.

9. A method for identifying BRCA1 mutations in breast and ovarian cancer tissue comprising the use of gene expression profiles or patterns from archival formalin-fixed paraffin-embedded (FFPE) specimens using a DNA array, wherein said gene profiling distinguishes between sporadic and hereditary types of cancer, and further wherein said method is independent of estrogen receptor (ER) status of the tissue, and further wherein the gene profiling is selected from a group of 128 selected genes as reflected in TABLE 4.

10. The method of claim 9, where at least 5 genes for the gene profiling are further selected from the 13 genes reflected in TABLE 5.

11. The method of claim 9, where at least 10 genes for the gene profiling are further selected from the 13 genes reflected in TABLE 5.

12. A method for identifying BRCA1 mutations in breast and ovarian cancer tissue comprising the use of gene expression profiles or patterns from archival formalin-fixed paraffin-embedded (FFPE) specimens using a DNA array, wherein said gene profiling distinguishes between sporadic and hereditary types of cancer, and further wherein said method is independent of estrogen receptor (ER) status of the tissue, and further wherein the DNA array is a DASL array, and further wherein the gene profiling is selected from a group of 128 selected genes as reflected in TABLE 4, and further wherein the sensitivity of detecting BRCA1 mutations by using said gene profiling method is greater than 70%, and still further wherein the specificity for correctly classifying sporadic BRCA1 mutations of said gene profiling method is equal to or greater than 50%.

13. The method of claim 12, wherein the sensitivity of detecting BRCA1 mutations by using said gene profiling method is greater than 80%, and still further wherein the specificity for correctly classifying BRCA1 mutations of said gene profiling method is equal to or greater than 70%.

14. The method of claim 1, wherein the sensitivity of detecting BRCA1 mutations by using said gene profiling method is greater than 90%, and still further wherein the specificity for correctly classifying BRCA1 mutations of said gene profiling method is equal to or greater than 80%.

15. The method of claim 12, where at least 5 genes for the gene profiling are further selected from the 13 genes reflected in TABLE 5.

16. The method of claim 12, where at least 10 genes for the gene profiling are further selected from the 13 genes reflected in TABLE 5.
